(19) United States
(12) Patent Application Publication
(10) Pub. No.: US 2026/0100665 A1
(43) Pub. Date: Apr. 9, 2026

(54) TRIANGULAR ALTERNATING CURRENT CHOKE FOR A TRACTION MOTOR OF A VEHICLE

(71) Applicant: GM GLOBAL TECHNOLOGY OPERATIONS LLC, DETROIT, MI (US)

(72) Inventors: Yilun Luo, Ann Arbor, MI (US); Muhammad Ahsan Zahid, Troy, MI (US); Ajay Mehta, Auburn Hills, MI (US); Edward W. Mellet, Rochester Hills, MI (US); Khorshed Mohammed Alam, Canton, MI (US); Mazharul Chowdhury, Canton, MI (US)

(21) Appl. No.: 18/905,539

(22) Filed: Oct. 3, 2024

(51) Int. Cl. H02P 27/06; B60L 50/14; B60L 50/40; H02M 1/44

(52) U.S. Cl. CPC H02P 27/06; B60L 50/14; B60L 50/40; H02M 1/44

(57) ABSTRACT

A vehicle is provided that includes a traction motor. The traction motor includes a direct current (DC) capacitor and a power printed circuit board (PCB) that converts DC electrical power received from the DC capacitor to alternating current (AC) electrical power. The traction motor further includes a stator having windings. The traction motor further includes a first phase connection, a second phase connection, and a third phase connection disposed between the power PCB/module and the windings of the stator. The first, second, and third phase connections provide an electrical connection between the power PCB/module and the windings of the stator and being arranged in a triangular configuration to provide the AC electrical power to the windings of the stator. The traction motor further includes a triangular alternating current choke surrounding the first phase connection, the second phase connection, and the third phase connection in the triangular configuration.

The subject disclosure relates to vehicles, and in particular to a triangular alternating current choke for a traction motor of a vehicle.

Modern vehicles (e.g., a car, a motorcycle, a boat, or any other type of automobile) may be equipped with one or more drive units for providing propulsion. A drive unit in a vehicle refers to the assembly that includes various components, such as the motor, transmission, and differential, that is responsible for converting energy from the motor (whether internal combustion or electric) into motion, which propels the vehicle. In electric vehicles (EVs), a traction motor is often part of the drive unit. The traction motor is an electric motor specifically designed to provide the torque for driving wheels of the vehicle. Traction motors may implement components, such as AC chokes, to ensure the longevity and reliability of electrical systems. It is desirable to provide AC chokes that reduce the material and space to achieve desired electromagnetic properties within a traction motor.

### SUMMARY

In one embodiment, a vehicle that includes a traction motor is provided. The traction motor includes a direct current (DC) capacitor and a power printed circuit board (PCB) that converts DC electrical power received from the DC capacitor to alternating current (AC) electrical power. The traction motor further includes a stator having windings. The traction motor further includes a first phase connection, a second phase connection, and a third phase connection disposed between the power PCB/module and the windings of the stator. The first, second, and third phase connections, the second phase connection, and the third phase connection provide an electrical connection between the power PCB/module and the windings of the stator and being arranged in a triangular configuration to provide the AC electrical power to the windings of the stator. The traction motor further includes a triangular AC choke surrounding the first phase connection, the second phase connection, and the third phase connection in the triangular configuration.

In addition to one or more of the features described herein, or as an alternative, further embodiments of the vehicle may include that the traction motor includes a wet area and a dry area, wherein the wet area includes the stator and the windings, and wherein the dry area includes the DC capacitor and the power PCB/module.

In addition to one or more of the features described herein, or as an alternative, further embodiments of the vehicle may include that the triangular AC choke is disposed in the wet area.

In addition to one or more of the features described herein, or as an alternative, further embodiments of the vehicle may include that the triangular AC choke is cooled by a coolant nozzle that sprays liquid coolant on the triangular AC choke.

In addition to one or more of the features described herein, or as an alternative, further embodiments of the vehicle may include that the triangular AC choke is at least partially submerged in a liquid coolant.

In addition to one or more of the features described herein, or as an alternative, further embodiments of the vehicle may include that the triangular AC choke is molded between the dry area and the wet area to provide a seal between the dry area and the wet area.

In addition to one or more of the features described herein, or as an alternative, further embodiments of the vehicle may include that the triangular AC choke is formed using a nanocrystalline material.

In addition to one or more of the features described herein, or as an alternative, further embodiments of the vehicle may include that the first phase connection and the second phase connection are separated by a distance, wherein the first phase connection and the third phase connection are separated by the distance, and wherein the second phase connection and the third phase connection are separated by the distance.

In addition to one or more of the features described herein, or as an alternative, further embodiments of the vehicle may include that a cross section of the triangular AC choke through which the first phase connection, the second phase connection, and the third phase connection in the triangular configuration pass through the triangular AC choke is defined by a substantially equilateral triangle.

In another embodiment, a traction motor for a vehicle is provided. The traction motor includes a direct current (DC) capacitor, a power printed circuit board (PCB) that converts DC electrical power received from the DC capacitor to alternating current (AC) electrical power, and a stator having windings. The traction motor further includes a first phase connection, a second phase connection, and a third phase connection disposed between the power PCB/module and the windings of the stator. The first phase connection, the second phase connection, and the third phase connection provide an electrical connection between the power PCB/module and the windings of the stator and being arranged in a triangular configuration to provide the AC electrical power to the windings of the stator. The traction motor further includes a triangular AC choke surrounding the first phase connection, the second phase connection, and the third phase connection in the triangular configuration. A cross section of the triangular AC choke through which the first phase connection, the second phase connection, and the third phase connection in the triangular configuration pass through the triangular AC choke is defined by a substantially equilateral triangle.

In addition to one or more of the features described herein, or as an alternative, further embodiments of the traction motor may include that the traction motor includes a wet area and a dry area, wherein the wet area includes the stator and the windings, and wherein the dry area includes the DC capacitor and the power PCB/module.

In addition to one or more of the features described herein, or as an alternative, further embodiments of the traction motor may include that the triangular AC choke is disposed in the wet area.

In addition to one or more of the features described herein, or as an alternative, further embodiments of the traction motor may include that the triangular AC choke is cooled by a coolant nozzle that sprays liquid coolant on the triangular AC choke.

In addition to one or more of the features described herein, or as an alternative, further embodiments of the traction motor may include that the triangular AC choke is at least partially submerged in a liquid coolant.

In addition to one or more of the features described herein, or as an alternative, further embodiments of the traction motor may include that the triangular AC choke is molded between the dry area and the wet area to provide a seal between the dry area and the wet area.

In addition to one or more of the features described herein, or as an alternative, further embodiments of the traction motor may include that the triangular AC choke is formed using a nanocrystalline material.

In addition to one or more of the features described herein, or as an alternative, further embodiments of the traction motor may include that the first phase connection and the second phase connection are separated by a distance, wherein the first phase connection and the third phase connection are separated by the distance, and wherein the second phase connection and the third phase connection are separated by the distance.

In another embodiment, a triangular alternating current (AC) choke is provided. The triangular AC choke includes a first portion, a second portion connected to the first portion and forming a first substantially sixty-degree angle, and a third portion connected to the first portion and forming a second substantially sixty-degree angle and connected to the second portion and forming a third substantially sixty-degree angle. The triangular AC choke defines an opening through which a first phase connection, a second phase connection, and a third phase connection pass.

In addition to one or more of the features described herein, or as an alternative, further embodiments of the triangular AC choke may include that the first phase connection, the second phase connection, and the third phase connection connect a direct current capacitor of a traction motor to windings of a stator of the traction motor.

In addition to one or more of the features described herein, or as an alternative, further embodiments of the triangular AC choke may include that the triangular AC choke is formed using a nanocrystalline material.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 schematically illustrates a vehicle having a traction motor and a triangular alternating current (AC) choke according to an embodiment;

FIGS. 2A, 2B, and 2C schematically illustrate the triangular AC choke of FIG. 1 according to an embodiment;

FIG. 3 schematically illustrates a detailed view of components within the traction motor, including the triangular AC choke, according to an embodiment;

FIG. 4 schematically illustrates a detailed view of components within the traction motor, including the triangular AC choke, according to an embodiment;

FIG. 5 schematically illustrates a detailed view of components within the traction motor, including the triangular AC choke, according to an embodiment; and

FIG. 6 schematically illustrates a detailed view of components within the traction motor, including the triangular AC choke, according to an embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

One or more embodiments described herein relates to a triangular alternating current (AC) choke for a traction motor of a vehicle.

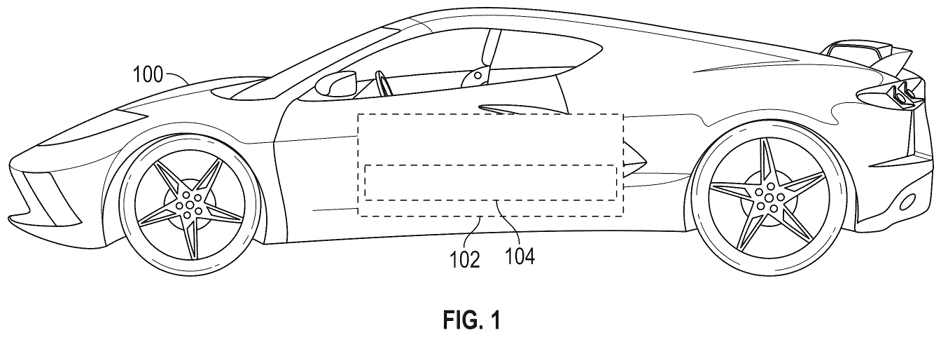

FIG. 1 is an illustration of a vehicle 100 having a traction motor 102 having a triangular AC choke 104, according to an embodiment. The vehicle 100 can be a car, a truck, a van, a bus, a motorcycle, a boat, or any other type of automobile. According to an embodiment, the vehicle 100 includes an internal combustion engine fueled by gasoline, diesel, or the like. According to another embodiment, the vehicle 100 is a hybrid electric vehicle partially or wholly powered by electrical power. According to another embodiment, the vehicle 100 is an electric vehicle powered by electrical power. According to one or more embodiments, the vehicle 100 is an autonomous or semi-autonomous vehicle. An autonomous vehicle is a vehicle that has self-driving capabilities.

According to one or more embodiments, the vehicle 100 includes the traction motor 102. As described herein, vehicles may use traction motors, such as the traction motor 102, to provide propulsion for a vehicle.

During operation, traction motors, such as the traction motor 102, can generate bearing currents and unwanted electrical noise. To mitigate these (e.g., to reduce bearing currents and unwanted electrical noise), traction motors may implement components, such as AC chokes, to ensure the longevity and reliability of electrical systems, particularly in high-power applications. An AC choke is an inductor used to filter out (e.g., block) high-frequency AC noise from a direct current (DC) power supply while allowing DC current to flow. Traditional AC chokes are often large in volume and high in complexity, posing significant challenges in terms of integration and efficiency. One example of an existing AC choke design is a linear choke in which three phase connections are arranged in a plane and the linear AC choke surrounds the three phases in a rectangular configuration.

AC chokes are often used in various applications, such as traction motors, to reduce bearing currents and mitigate electromagnetic interference (EMI). These chokes ensure the longevity and reliability of electrical systems, particularly in high-power applications such as electric vehicles. Existing AC chokes involve linear choke designs that often result in increased weight and complexity, making them less suitable for applications where space and efficiency are important. Additionally, the large volume of traditional AC chokes can limit packaging opportunities and complicate the integration process within compact systems.

One or more embodiments described herein overcome these and other shortcomings by introducing a novel triangular AC choke design (e.g., the triangular AC choke 104) that reduces the amount of material and mass needed to suppress circulating currents. The triangular AC choke 104 increases inductance by reducing flux length and enhancing inter-cable field coupling, resulting in a more compact and efficient solution. This design also allows for improved integration between the housing of the traction motor and the inverter, enabling better mitigation of common-mode effects and enhancing overall system performance. According to one or more embodiments, various cooling approaches are provided to further reduce material used in the triangular AC choke 104 and support higher frequency operations, thereby optimizing the choke's efficiency and reliability.

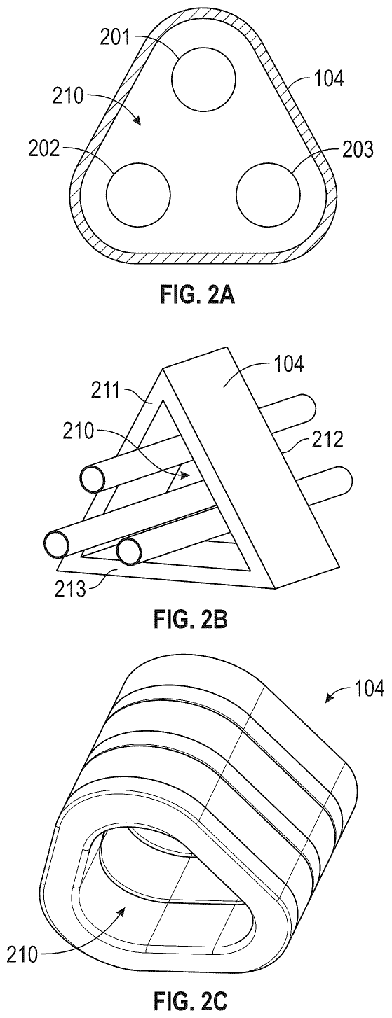

FIG. 2A illustrates a cross-sectional view of the triangular AC choke 104, showcasing the arrangement phase connections passing through the triangular AC choke 104 according to an embodiment. For example, the phase connections include a first phase 201, a second phase 202, and a third phase 203. The triangular AC choke 104 is designed to surround these phase connections in a triangular configuration as shown, enhancing inductance by reducing flux length and improving inter-cable field coupling. This configuration is useful for the efficient distribution of electrical power within the traction motor 102, contributing to a more compact and cost-effective solution compared to traditional linear choke designs.

FIG. 2B illustrates the triangular AC choke 104, highlighting its structural components, according to an embodiment. The triangular AC choke 104 includes a first portion 211, a second portion 212, and a third portion 213. The first portion 211 is connected to the second portion 212, forming a first substantially sixty-degree angle. The third portion 213 is connected to both the first portion 211 and the second portion 212, forming second and third substantially sixty-degree angles, respectively. This configuration defines the triangular shape of the triangular AC choke 104, which provides for enhancing inductance by reducing flux length and improving inter-cable field coupling. The triangular structure allows for efficient integration within the traction motor 102, contributing to a more compact and cost-effective solution compared to traditional linear choke designs.

FIG. 2C illustrates the triangular AC choke 104 according to an embodiment. The triangular AC choke 104 is designed to surround the first phase connection, second phase connection, and third phase connection in a triangular configuration. This configuration enhances inductance by reducing flux length and improving inter-cable field coupling. The triangular AC choke 104 is compact and cost-effective, contributing to efficient integration within the traction motor 102. According to one or more embodiments, the triangular AC choke 104 is formed using a nanocrystalline material, which further enhances its performance and efficiency. According to one or more embodiments, other types of materials can be used to form the triangular AC choke 104.

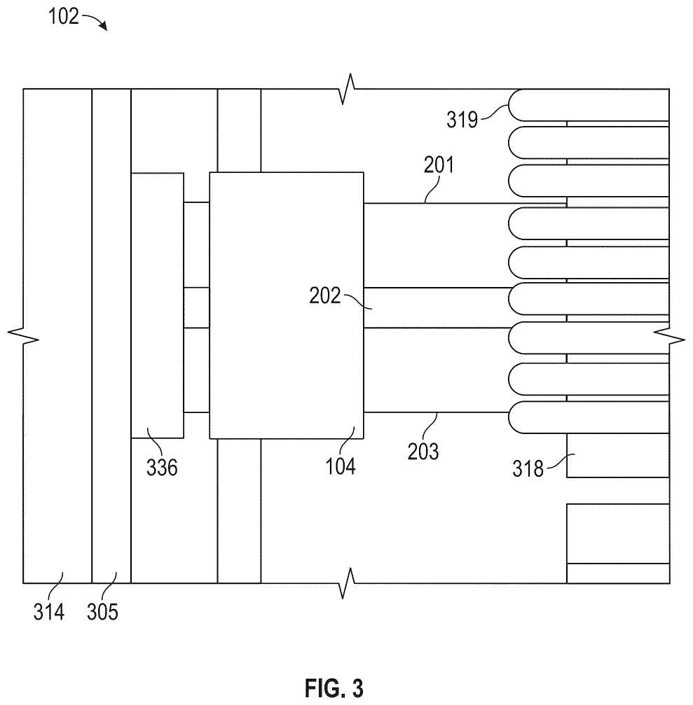

FIG. 3 illustrates a detailed schematic view of the traction motor 102, highlighting the arrangement and interaction of its components including the triangular AC choke 104, according to an embodiment. As shown, the traction motor 102 includes the triangular AC choke 104, phase connections (e.g., the first phase 201, the second phase 202, and the third phase 203), a DC capacitor 314, a stator 318, and windings 319.

The first phase 201, second phase 202, and third phase 203 connections are electrically connected to the windings 319 of the stator 318. The phase connections provide electrical connections between a power printed circuit board (PCB)/module 305 (which receives power from the DC capacitor 314) and the windings 319 of the stator 318. The power PCB/module 305 can be a PCB or a dedicated module handling DC to AC conversion. These phase connections are arranged in a triangular configuration, which is useful for the efficient distribution of electrical power within the motor and packaging the triangular AC choke 104 effectively.

The triangular AC choke 104 is shown surrounding the first phase 201, second phase 202, and third phase 203 connections. These phase connections are arranged in a triangular configuration, which enhances inductance by reducing flux length and improving inter-cable field coupling. The triangular AC choke 104 is designed to increase inductance by reducing flux length and enhancing inter-cable field coupling. This design results in a more compact and efficient solution compared to traditional linear choke designs. According to one or more embodiments, the triangular AC choke 104 is formed using a nanocrystalline material, which further enhances the performance and efficiency of the triangular AC choke 104.

This design results in a more compact and efficient solution compared to traditional linear choke designs.

The DC capacitor 314 stabilizes voltage and provides the electrical power to the windings 319 of the stator 318 through the power PCB/module 305 to the phase connections (e.g., the first phase 201, the second phase 202, and the third phase 203). The power PCB/module 305 is responsible for converting DC power to AC power. The windings 319 are responsible for generating the magnetic field used during operation of the traction motor 102. The windings 319 are precisely arranged to maximize the efficiency of the magnetic field generation and ensure smooth motor performance.

The triangular AC choke 104 is characterized by the structure, which includes, as shown in FIG. 2B, a first portion 211, a second portion 212 connected to the first portion 211 and forming a first substantially sixty-degree angle, and a third portion 213 connected to the first portion 211 and forming a second substantially sixty-degree angle and connected to the second portion 212 and forming a third substantially sixty-degree angle. This configuration defines an opening 210 through which the first phase 201, the second phase 202, and the third phase 203 pass. The cross section of the triangular AC choke 104, shown in FIG. 2A, through which the first phase 201, the second phase 202, and the third phase 203 pass is defined by a substantially equilateral triangle.

According to one or more embodiments, the traction motor 102 includes a current sensor 336, which is responsible for monitoring the electrical current flowing through the phase connections. The current sensor 336 provides real-time data on the motor's performance, allowing for precise control and optimization of the motor's operation.

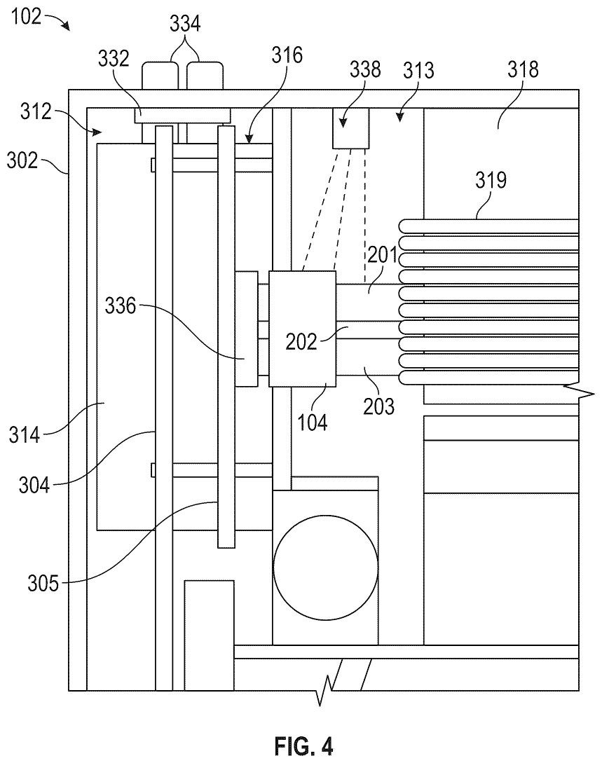

FIG. 4 illustrates a detailed schematic view of the traction motor 102, highlighting the arrangement and interaction of its components, including the triangular AC choke 104, according to an embodiment. The traction motor 102 includes a housing 302.

The housing 302 encloses the various components of the traction motor 102, providing structural support and protection. The traction motor 102 includes, within the housing 302, a dry area 312 that houses the power electronics and certain components of the traction motor 102, and a wet area 313 that houses other components of the traction motor 102.

The traction motor 102 includes DC terminals 334 that are connected to a DC choke 332, which is responsible for stabilizing the voltage and providing the power to DC capacitor 314. The DC capacitor 314 can be strategically placed to optimize the electrical performance and reduce any potential fluctuations in the power supply. The dry area 312 also houses PCB 304 and the power PCB/module 305, which are part of the control and gate drive circuitry for the traction motor 102 and are useful for the operation of the traction motor 102. These components work together to ensure efficient operation and integration within the vehicle 100.

As in FIG. 3, the traction motor 102 of FIG. 4 includes the first phase 201, second phase 202, and third phase 203 connections, which are electrically connected to the power PCB/module 305 and to the windings 319 of the stator 318 within the wet area 313. Electrical power flows from the DC terminals 334 through the DC capacitor 314 to the power PCB/module 305 as DC electrical power. The power PCB/module 305 converts the DC electrical power to AC electrical power, and the AC electrical power is then transmitted to the windings 319 of the stator 318 via the phase connections (e.g., the first phase 201, the second phase 202, and the third phase 203). The phase connections provide electrical connections between the DC capacitor 314 and the windings 319 of the stator 318. These phase connections are arranged in a triangular configuration, which is useful for the efficient distribution of electrical power within the motor.

The triangular AC choke 104 is shown surrounding the first phase 201, second phase 202, and third phase 203 connections. These phase connections are arranged in a triangular configuration, which enhances inductance by reducing flux length and improving inter-cable field coupling. For example, the flux length of the triangular AC choke 104 is reduced as compared to a linear AC choke design. The triangular AC choke 104 is designed to increase inductance by reducing flux length and enhancing inter-cable field coupling. This design results in a more compact and efficient solution compared to traditional linear choke designs. According to one or more embodiments, the triangular AC choke 104 is formed using a nanocrystalline material, which further enhances the performance and efficiency of the triangular AC choke 104.

According to one or more embodiments, the traction motor 102 includes a current sensor 336, which is responsible for monitoring the electrical current flowing through the phase connections. The current sensor 336 provides real-time data on the motor's performance, allowing for precise control and optimization of the motor's operation.

The stator 318 and the windings 319 are located in the wet area 313 of the traction motor 102, where they are exposed to cooling mechanisms to maintain desirable operating temperatures. A coolant block 316 and spray nozzle 338 are part of the cooling system, ensuring that the components remain within their desired temperature range during operation. The spray nozzle 338 can spray liquid coolant, such as oil, on the triangular AC choke 104. The liquid coolant is used to actively extract heat from the triangular AC choke 104, especially during high-frequency operation. This arrangement can be used for various traction motor topologies, such as end and top or side integrated inverters.

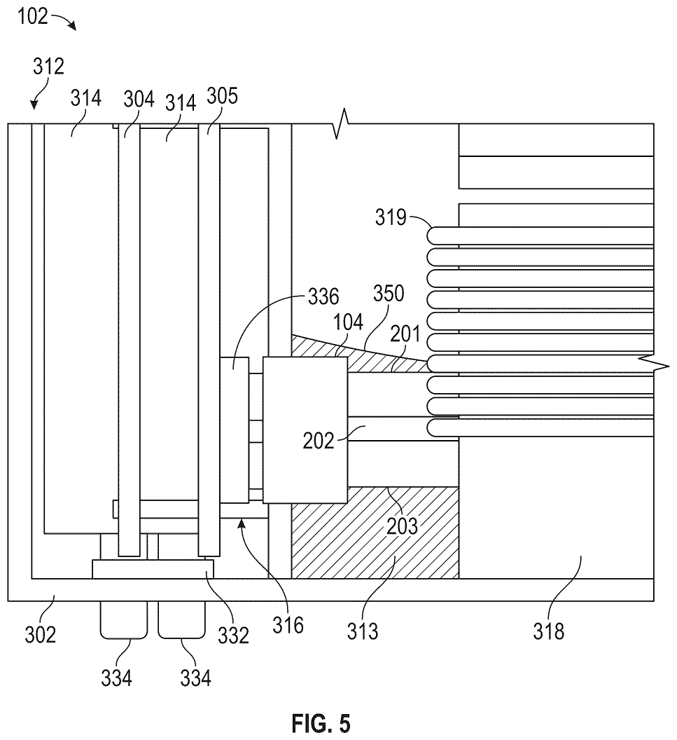

FIG. 5 illustrates a detailed schematic view of the traction motor 102, highlighting the arrangement and interaction of its key components including the triangular AC choke 104, according to an embodiment. In this embodiment, passive cooling is provided for the triangular AC choke 104.

As shown, the triangular AC choke 104 is disposed in a lower portion of the wet area 313 such that the triangular AC choke 104 is at least partially submerged in a liquid coolant (e.g., oil 350 shown in FIG. 5). By submerging the triangular AC choke 104 at least partially in the liquid coolant, heat dispersion is provided to the triangular AC choke 104, thereby cooling the triangular AC choke 104. This provides for the triangular AC choke 104 to be reduced in size/volume and not heat up beyond a desired temperature during operation.

As a result of the placement of the triangular AC choke 104 within the wet area 313 of the triangular AC choke 104, other components of the traction motor 102 are also relocated. For example, the DC capacitor 314, the DC choke 332, the DC terminals 334, and the current sensor 336 are relocated relative to their positions shown in the embodiment of FIG. 4. This arrangement aids in maintaining relatively short lengths of the phase connections (e.g., the first phase 201, the second phase 202, and the third phase 203) between the power PCB/module 305 and the windings 319 of the stator 318. This arrangement can be used for various traction motor topologies if the inverter is end integrated.

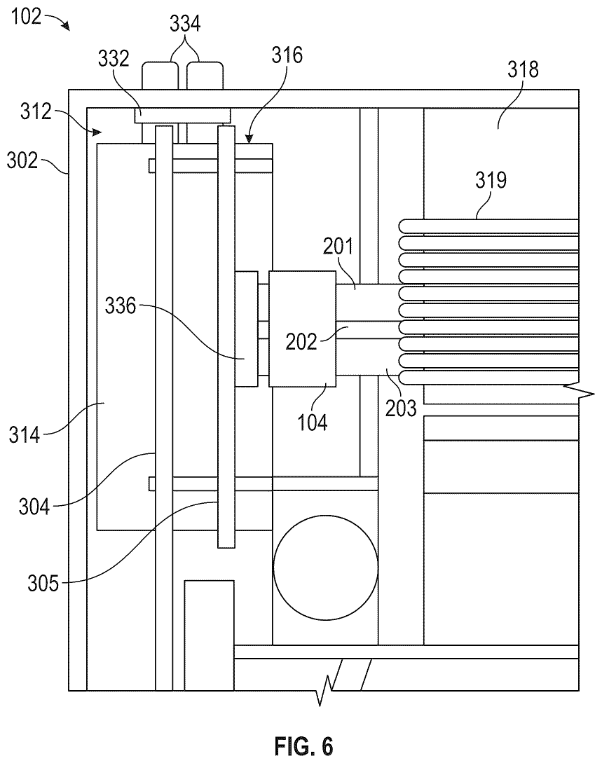

FIG. 6 illustrates a detailed schematic view of the traction motor 102, highlighting the arrangement and interaction of its key components including the triangular AC choke 104, according to an embodiment. According to one or more embodiments, the triangular AC choke 104 is small enough to be packaged into the inverter volume and to take advantage of the coolant block 316 for the power modules. That is, the coolant block 316 can be used to dissipate heat from the triangular AC choke 104. To utilize the cooling properties of the coolant block 316, the triangular AC choke 104 is positioned in direct proximity to (e.g., touching) the coolant block 316.

The coolant block 316 may be designed to dissipate heat from high-temperature components such as the triangular AC choke 104 and/or other power electronics (e.g., the power PCB/module 305). The coolant block 316 may be made of a thermally conductive material, like copper or aluminum, with channels or chambers through which a liquid coolant, such as water, oil, or a glycol mixture, flows. The coolant absorbs heat from the triangular AC choke 104 as it passes through the block, which is then carried away to a radiator or heat exchanger, thereby cooling the triangular AC choke 104 effectively.

This arrangement can be used for various traction motor topologies and different inverter orientations. The additional cooling provides for the triangular AC choke 104 and does not heat up significantly during operation.

The triangular AC choke 104 offers several significant improvements over traditional linear choke designs, enhancing the overall performance and efficiency of traction motors, and thus the vehicles that implement them, as follows.
Increased Inductance: The triangular AC choke 104 increases inductance by reducing flux length and enhancing inter-cable field coupling, which provides for better suppression of circulating currents, which can negatively impact bearing life and traction motor performance.
Compact and Cost-Effective Design: The triangular configuration of the triangular AC choke 104 provides for a more compact design compared to traditional linear chokes. This reduction in size not only saves space but also reduces the amount of material required, leading to lower manufacturing times and complexities.
Improved Integration: The compact size and triangular configuration of the triangular AC choke 104 enable better integration between the motor housing and inverter. This improved integration helps mitigate common-mode effects, reducing electromagnetic interference (EMI) and enhancing overall system performance.
Enhanced Cooling Opportunities: The design of the triangular AC choke 104 allows for cooling the triangular AC choke 104, such as using liquid coolant spray or submersion in liquid coolant. These cooling techniques help to effectively extract heat, supporting higher frequency operations and further reducing the size of the triangular AC choke 104 by requiring less nanocrystalline material.

Overall, the technical benefits of the various embodiments described herein contribute to a more efficient, reliable, and cost-effective traction motor system, enhancing the performance and functionality of electric vehicles and/or other devices or vehicles that use such drive units.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
traction motor comprising:
a direct current (DC) capacitor;
a power printed circuit board (PCB) that converts DC electrical power received from the DC capacitor to alternating current (AC) electrical power;
a stator comprising windings;
a first phase connection, a second phase connection, and a third phase connection disposed between the power PCB/module and the windings of the stator, the first phase connection, the second phase connection, and the third phase connection providing an electrical connection between the power PCB/module and the windings of the stator and being arranged in a triangular configuration to provide the AC electrical power to the windings of the stator; and
a triangular AC choke surrounding the first phase connection, the second phase connection, and the third phase connection in the triangular configuration.

2. The vehicle of claim 1, wherein the traction motor comprises a wet area and a dry area, wherein the wet area comprises the stator and the windings, and wherein the dry area comprises the DC capacitor and the power PCB/module.

3. The vehicle of claim 2, wherein the triangular AC choke is disposed in the wet area.

4. The vehicle of claim 3, wherein the triangular AC choke is cooled by a coolant nozzle that sprays liquid coolant on the triangular AC choke.

5. The vehicle of claim 3, wherein the triangular AC choke is at least partially submerged in a liquid coolant.

6. The vehicle of claim 2, wherein the triangular AC choke is molded between the dry area and the wet area to provide a seal between the dry area and the wet area.

7. The vehicle of claim 1, wherein the triangular AC choke is formed using a nanocrystalline material.

8. The vehicle of claim 1, wherein the first phase connection and the second phase connection are separated by a distance, wherein the first phase connection and the third phase connection are separated by the distance, and wherein the second phase connection and the third phase connection are separated by the distance.

9. The vehicle of claim 1, wherein a cross section of the triangular AC choke through which the first phase connection, the second phase connection, and the third phase connection in the triangular configuration pass through the triangular AC choke is defined by a substantially equilateral triangle.

10. A traction motor for a vehicle, the traction motor comprising:
a direct current (DC) capacitor;
a power printed circuit board (PCB) that converts DC electrical power received from the DC capacitor to alternating current (AC) electrical power;
a stator comprising windings;
a first phase connection, a second phase connection, and a third phase connection disposed between the power PCB/module and the windings of the stator, the first phase connection, the second phase connection, and the third phase connection providing an electrical connection between the power PCB/module and the windings of the stator and being arranged in a triangular configuration to provide the AC electrical power to the windings of the stator; and
a triangular alternating current (AC) choke surrounding the first phase connection, the second phase connection, and the third phase connection in the triangular configuration, wherein a cross section of the triangular AC choke through which the first phase connection, the second phase connection, and the third phase connection in the triangular configuration pass through the triangular AC choke is defined by a substantially equilateral triangle.

11. The traction motor of claim 10, further comprising a wet area and a dry area, wherein the wet area comprises the stator and the windings, and wherein the dry area comprises the DC capacitor and the power PCB/module.

12. The traction motor of claim 11, wherein the triangular AC choke is disposed in the wet area.

13. The traction motor of claim 12, wherein the triangular AC choke is cooled by a coolant nozzle that sprays liquid coolant on the triangular AC choke.

14. The traction motor of claim 12, wherein the triangular AC choke is at least partially submerged in a liquid coolant.

15. The traction motor of claim 11, wherein the triangular AC choke is molded between the dry area and the wet area to provide a seal between the dry area and the wet area.

16. The traction motor of claim 10, wherein the triangular AC choke is formed using a nanocrystalline material.

17. The traction motor of claim 10, wherein the first phase connection and the second phase connection are separated by a distance, wherein the first phase connection and the third phase connection are separated by the distance, and wherein the second phase connection and the third phase connection are separated by the distance.

18. A triangular alternating current (AC) choke comprising:
a first portion;
a second portion connected to the first portion and forming a first substantially sixty-degree angle; and
a third portion connected to the first portion and forming a second substantially sixty-degree angle and connected to the second portion and forming a third substantially sixty-degree angle,
wherein the triangular AC choke defines an opening through which a first phase connection, a second phase connection, and a third phase connection pass.

19. The triangular AC choke of claim 18, wherein the first phase connection, the second phase connection, and the third phase connection connect a direct current capacitor of a traction motor to windings of a stator of the traction motor.

20. The triangular AC choke of claim 18, wherein the triangular AC choke is formed using a nanocrystalline material.
